(19) United States
(12) Patent Application Publication
(10) Pub. No.: US 2025/0342641 A1
(43) Pub. Date: Nov. 6, 2025

(54) METHOD, APPARATUS, DEVICE, AND MEDIUM FOR RENDERING TASK PROCESSING

(71) Applicant: Beijing Zitiao Network Technology Co., Ltd., Beijing (CN)

(72) Inventors: Qiuhu Tang, Beijing (CN); Jing Du, Beijing (CN); Shiyang Zhang, Beijing (CN)

(21) Appl. No.: 18/871,074

(22) PCT Filed: Aug. 30, 2023
(86) PCT No.: PCT/CN2023/115859

§ 371 Date: Dec. 2, 2024

(30) Foreign Application Priority Data
Sep. 16, 2022 (CN) 202211129538.3

(51) Int. Cl. G06T 15/00

(52) U.S. Cl. CPC G06T 15/00

(57) ABSTRACT

Embodiments of the disclosure provide a method, apparatus, device, and medium for rendering task processing. The method for rendering task processing includes: obtaining, at a rendering task management component and based on a rendering task, configuration information of a rendering node for executing the rendering task; generating, based on the configuration information, a rendering instruction for invoking the rendering node; and sending the rendering instruction to the rendering node, to cause the rendering node to execute the rendering task. In this way, the rendering task management component can invoke a corresponding rendering node through the configuration information of the rendering node. When different rendering nodes are invoked, the rendering task management component only needs to modify the corresponding configuration information without any other additional modifications, thereby simplifying the invoking process of the rendering node.

The present application claims priority to Chinese Patent Application No. 202211129538.3, filed on Sep. 16, 2022, and entitled ‘METHOD, APPARATUS, DEVICE, AND MEDIUM FOR RENDERING TASK PROCESSING’, which is incorporated herein by reference in its entirety.

### FIELD

Example embodiments of the present disclosure generally relate to the field of computers, and in particular to a method, apparatus, device, and computer-readable storage medium for rendering task processing.

### BACKGROUND

Image rendering is a very important link in the field of image processing. Through the rendering technology; images can have better visual experience effects. Therefore, the rendering technology has been widely used in recent years. In order to provide more diversified rendering services, more and more rendering nodes (also referred to as ‘rendering engines’) are used by rendering service providers. However, different rendering nodes usually have different interaction methods. In the traditional rendering task processing solution, different interaction interfaces need to be developed for different rendering nodes, resulting in a lack of flexibility in invoking the rendering nodes.

### SUMMARY

In a first aspect of the present disclosure, a method of rendering task processing is provided. The method includes obtaining, based on a rendering task, configuration information of a rendering node for executing the rendering task. The method also includes generating, based on the configuration information, a rendering instruction for invoking the rendering node. The method further includes sending the rendering instruction to the rendering node, to cause the rendering node to execute the rendering task.

In a second aspect of the present disclosure, a method of rendering task processing is provided. The method includes receiving a rendering instruction, the rendering instruction being generated by a rendering task management component based on configuration information of a rendering node. The method further includes executing a rendering task based on the rendering instruction.

In a third aspect of the present disclosure, a rendering task management component is provided. The rendering task management component includes a configuration information obtaining module configured to obtain, based on a rendering task, configuration information of a rendering node for executing the rendering task. The rendering task management component also includes a rendering instruction generation module configured to generate, based on the configuration information, a rendering instruction for invoking the rendering node. The rendering task management component further includes a rendering instruction sending module configured to send the rendering instruction to the rendering node, to cause the rendering node to execute the rendering task.

In a fourth aspect of the present disclosure, a rendering node is provided. The rendering node includes a rendering instruction receiving module configured to receive a rendering instruction, the rendering instruction being generated by a rendering task management component based on configuration information of the rendering node. The rendering node further includes a rendering task execution module configured to execute a rendering task based on the rendering instruction.

In a fifth aspect of the present disclosure, an electronic device is provided. The device includes at least one processing unit and at least one memory coupled to the at least one processing unit and storing instructions for execution by the at least one processing unit, the instructions, when executed by the at least one processing unit, causing the device to perform the method of the first aspect or the second aspect.

In a sixth aspect of the present disclosure, a computer-readable storage medium having a computer program stored thereon, the computer program being executed by a processor to implement the method of the first aspect or the second aspect.

It should be understood that the content described in the Summary section is neither intended to identify key or important features of embodiments of the present disclosure, nor is it intended to be used to limit the scope of the present disclosure. Other features of the present disclosure will become easily comprehensible through the following description.

### BRIEF DESCRIPTION OF THE DRAWINGS

The above and other features, advantages, and aspects of embodiments of the present disclosure become more apparent with reference to the following detailed description and in conjunction with the accompanying drawings. In the drawings, the same or similar reference numerals denote the same or similar elements, where:

FIG. 1 shows a schematic diagram of an example environment in which embodiments of the present disclosure can be applied:

FIG. 2 shows a flowchart of a signaling flow of rendering task processing according to some embodiments of the present disclosure:

FIG. 3 shows a flowchart of rendering task processing according to some embodiments of the present disclosure:

FIG. 4 shows a flowchart of a further rendering task processing according to some embodiments of the present disclosure:

FIG. 5 shows a block diagram of an apparatus for rendering task processing at a rendering task management component according to some embodiments of the present disclosure:

FIG. 6 shows a block diagram of a further apparatus for rendering task processing at a rendering node according to some embodiments of the present disclosure: and

FIG. 7 shows a block diagram of a device capable of implementing a plurality of embodiments of the present disclosure.

### DETAILED DESCRIPTION OF EMBODIMENTS

Embodiments of the present disclosure will be described in more detail below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and embodiments of the present disclosure are only for example purposes, and are not intended to limit the scope of protection of the present disclosure.

In the description of the embodiments of the present disclosure, the term ‘include/comprise’ and similar terms should be understood as open inclusion, that is. ‘include/comprise but not limited to’. The term ‘based on’ should be understood as ‘at least partially based on’. The term ‘an embodiment’ or ‘the embodiment’ should be understood as ‘at least one embodiment’. The term ‘some embodiments’ should be understood as ‘at least some embodiments’. Other explicit and implicit definitions may also be included below.

It may be understood that the data involved in the technical solutions of the present application (including but not limited to data itself, data obtaining, or data use) shall comply with the requirements of the corresponding laws, regulations, and related provisions.

It may be understood that before the technical solutions disclosed in the embodiments of the present disclosure are used, the user shall be informed of the type, scope of use, usage scenario, and the like of the personal information involved in the present disclosure in an appropriate manner in accordance with the relevant laws and regulations, and the authorization of the user shall be obtained.

For example, in response to receiving an active request from a user, prompt information is sent to the user to explicitly prompt the user that the operation requested by the user needs to obtain and use the personal information of the user. Therefore, the user can select whether to provide personal information to the software or hardware (such as an electronic device, an application, a server, or a storage medium) that performs the operation of the technical solution of the present disclosure according to the prompt information.

As an optional but non-limiting implementation, in response to receiving an active request from a user. the prompt information may be sent to the user in a pop-up window, for example. The prompt information may be presented in the pop-up window in text. In addition, the pop-up window may also carry a selection control for the user to select ‘agree’ or ‘disagree’ to provide personal information to the electronic device.

It may be understood that the process of above notification and obtaining the authorization of the user are only schematic, and do not limit the implementation of the present disclosure. Other methods that meet the relevant laws and regulations may also be applied to the implementation of the present disclosure.

In the present disclosure, the terms ‘rendering node’ and ‘rendering engine’ are equivalent to each other and are interchangeable.

As discussed in the present disclosure, the rendering technology has been widely used in recent years. In addition, with the popularization and wide application of the rendering technology, users have increasingly higher requirements for rendering quality. In order to provide more diversified rendering services, more and more rendering nodes (also referred to as ‘rendering engines’) developed by third parties have begun to be used by rendering service providers. Specifically, in addition to using self-developed rendering nodes, a rendering service provider will enrich rendering services with rendering nodes developed by third parties. In recent years. cloud rendering technology has also been proposed and has attracted more and more attention. In the cloud rendering scenario, a rendering service provider has the opportunity to access and invoke more rendering nodes developed by third parties. Therefore, in the cloud rendering scenario, the demand of the rendering service provider to invoke the rendering nodes developed by third parties is also more frequent.

In the traditional rendering task processing solution, a rendering task management component (such as a rendering primary program) invokes a rendering node to execute a corresponding rendering task. However. since different rendering nodes usually have different interaction methods, the collaborative interaction methods between the rendering task management component and different rendering nodes are also different. As an example, rendering nodes A. B, and C may be invoked by a rendering service provider and have their own invoking interfaces A0, B0, and C0, respectively. When the rendering node A needs to be invoked, the rendering task management component needs to include code A1 of the invoking interface A0. Correspondingly, when the rendering node B/C needs to be invoked, the rendering task management component needs to include code B1/C1 of the invoking interface B0/C0, respectively. It can be seen that in the traditional rendering task processing solution, whenever the invoked rendering node changes, the rendering task management component needs to be modified to include code for invoking the corresponding rendering node, which is not conducive to the expansion and maintenance of the rendering service.

Therefore, a flexible and efficient rendering task processing solution is needed to simplify the interaction between the rendering task management component and a plurality of different rendering nodes.

According to various embodiments of the present disclosure, a solution for rendering task processing is provided. According to the solution of the present disclosure, each rendering node has its own configuration information, and the rendering task management component no longer invokes each rendering node by modifying the internal code, but generates a rendering instruction based on the configuration information of the rendering node to implements the invocation of the corresponding rendering node. In this way, when the invoked rendering node changes, the rendering task management component does not need to make additional modifications, but only needs to change the configuration information of the corresponding node, which greatly simplifies the interaction between the rendering task management component and the rendering node.

### Example Environment

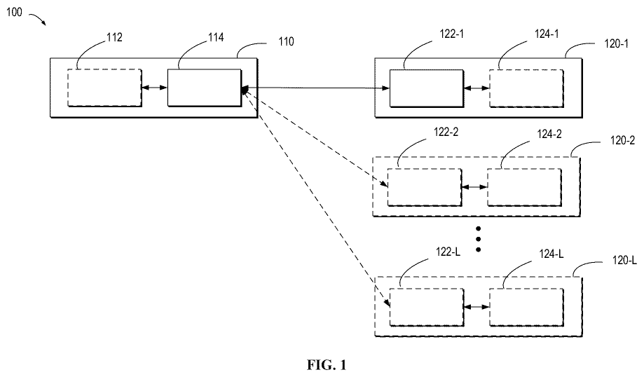

FIG. 1 shows a schematic diagram of an example environment 100 in which embodiments of the present disclosure can be implemented. The environment 100 involves a rendering task processing environment. In some embodiments, the environment 100 is a cloud rendering environment. As shown in FIG. 1, the environment 100 includes a rendering task management component 110 and L rendering nodes 120-1, 120-2 . . . 120-L (wherein L is an integer greater than 1). For case of discussion, the rendering nodes 120-1, 120-2 . . . 120-L may be collectively or individually referred to as the rendering node 120.

In the present disclosure, the rendering task management component 110 refers to any appropriate apparatus/device/module/unit that manages/controls the execution of rendering tasks. In a specific embodiment. the rendering task management component 110 is implemented as a rendering primary program. In further implementations, the rendering task management component 110 may be implemented as an application terminal including a graphical interface. In further implementations, the rendering task management component 110 may also be implemented in other forms. The various embodiments of the present disclosure are not limited in the specific implementation of the rendering task management component 110.

In some embodiments, the rendering task management component 110 is responsible for controlling the entire processing flow of the rendering task, that is, maintaining and controlling each step/operation of the rendering task, such as image codec, artificial intelligence (AI) algorithm, and controlling the rendering node 120 to execute a specific rendering task.

In some embodiments, the rendering node 120 receives the invocation of the rendering task management component 110 and executes a specific rendering task. In a specific embodiment, the rendering node 120 receives an A1 processing result, data to be rendered, a rendering instruction, and the like to execute a specific rendering task. In some embodiments, the rendering instruction may indicate any operation executed by the rendering task, including but not limited to starting a renderer, loading rendering data, controlling a camera. and controlling a rendering frame time.

In some embodiments, the rendering node 120 is a self-developed rendering node of the rendering service provider. Alternatively, or in addition, in some embodiments, the rendering node 120 is a rendering node developed by a third party and can be invoked by the rendering service provider.

Further, in the example environment 100 of FIG. 1, the rendering task management component 110 and the rendering node 120 are shown as independent modules, but in a real rendering task processing scenario. the rendering task management component 110 and the rendering node 120 may be located in separate physical entities or in the same physical entity. The embodiments of the present disclosure are not limited in this respect.

In some embodiments, the rendering task management component 110 and the rendering node 120 run in different processes independent of each other.

As shown in FIG. 1, the rendering task management component 110 includes a rendering control module 112 and a first dedicated module 124 (sometimes also referred to as a ‘client module’), wherein the rendering control module 112 is for management/control of the rendering process, and the first dedicated module 124 is for implementing the invocation of the rendering node 120. In some embodiments, the rendering control module 112 and/or the first dedicated module 124 may be implemented as a computer plug-in.

As shown in FIG. 1, each rendering node 120 includes a respective second dedicated module 122 (sometimes also referred to as a ‘server module’) and a renderer 124. The second dedicated module 122 is used to interact with the rendering task management component 110. Specifically, the second dedicated module 122 receives a rendering instruction from the rendering task management component 110 and sends it to the renderer 124. The renderer 124 is used to execute a specific rendering task. As shown in FIG. 1, the rendering nodes 120-1. 120-2, and 120-L include respective second dedicated modules 122-1. 122-2, and 122-L and renderers 124-1. 124-2, and 124-L, respectively.

In some embodiments, the second dedicated module 122 interacts with the renderer 124 to execute a specific rendering task. In some embodiments, the second dedicated module 122 converts the received rendering instruction into a rendering task execution instruction that drives the renderer 124 to execute a corresponding rendering task. In some embodiments, the rendering task execution instruction implements behavior control of the renderer 124, such as initialization of the renderer 124, rendering resolution, rendering frame rate, loading of rendering data (rendering effect and/or level), control of the camera, and control of the rendering frame time.

In some embodiments, the renderer 124 provides a corresponding interface to the second dedicated module 122, and the second dedicated module 122 may interact with the rendering task execution instruction through the corresponding interface to implement the invocation and behavior control of the renderer 124.

Alternatively, in some embodiments, the renderer 124 includes a first module and a second module that implements a rendering function, wherein the first module is used to implement creation, running, and destruction of the renderer 124. Further, in some embodiments, the first module also receives a rendering task execution instruction from the second dedicated module 124 and invokes the second module to implement a specific rendering function.

In some embodiments, the renderer 124 and/or the second dedicated module 122 may be implemented as a computer plug-in.

In some embodiments, the rendering task management component 110 communicates with the second dedicated module 122 of the different rendering node 120 through the first dedicated module 114. In other words. the first dedicated module 114 is universal for different rendering nodes 120. In addition, it should also be understood that in the specific implementation of FIG. 1, although each rendering node 120 is connected to only one rendering task management component 110, the rendering node 120 may also be invoked by other rendering task management components. In other words, the second dedicated module 122 of the rendering node 120 is also universal for different rendering task management components 110.

In some embodiments, the task management component 110 is connected to the second dedicated module 122 of the rendering node 120 through the first dedicated module 114, to implement interaction between the task management component 110 and the rendering node 120 on the rendering instruction and rendering data (including data to be rendered and a rendering result).

In some embodiments, the first dedicated module 114 establishes a connection with the second dedicated module 122 for subsequent communication. Additionally, in some embodiments, the first dedicated module 114 requests to start the renderer 124 of the rendering node 120, for example, the first dedicated module 114 sends a rendering instruction for requesting to start the renderer 124 to the second dedicated module 122. Alternatively, in some embodiments, in response to establishment of the connection between the first dedicated module 114 and the second dedicated module 122, the second dedicated module 122 automatically triggers a start process of the renderer 124.

In some embodiments, the first dedicated module 114 sends a rendering instruction to the second dedicated module 122, wherein the rendering instruction includes at least one control parameter for controlling execution of the rendering task. Additionally, the first dedicated module 114 may also receive a response message for the rendering instruction sent by the second dedicated module 122. Alternatively, or in addition, in some embodiments, the first dedicated module 114 sends data to be rendered to the second dedicated module 122 and receives a rendering result from the second dedicated module 122.

In some embodiments, the second dedicated module 122 receives a connection request from the first dedicated module 114 to establish a connection with the first dedicated module 114. In some embodiments, the second dedicated module 122 is started and waits for access of the first dedicated module 114 (such as listening for a connection request from the first dedicated module 114). Additionally, in some embodiments, in response to an establishment of the connection with the first dedicated module 114 or receiving the rendering instruction for starting the renderer 124 from the first dedicated module 114, the second dedicated module 122 starts the renderer 124. Alternatively, or in addition, in some embodiments, the second dedicated module 122 receives a rendering instruction from the first dedicated module 114 and passes it to the renderer 124, wherein the rendering instruction includes at least one control parameter for controlling execution of the rendering task. In some embodiments, the second dedicated module 122 receives data to be rendered sent by the first dedicated module 114 and sends it to the renderer 124. Correspondingly, the second dedicated module 122 receives a rendering result from the renderer 124 and sends the rendering result to the first dedicated module 114.

In the present disclosure, the communication between the first dedicated module 114 and the second dedicated module 122 may be any appropriate communication method. An example of the communication method is wired communication. A further example of the communication method is wireless communication. In short, any appropriate communication method may be used between the first dedicated module 114 and the second dedicated module 122 to implement cross-device communication.

Alternatively, the task management component 110 and the rendering node 120 may be located on the same physical device/container. In this case, the first dedicated module 114 and the second dedicated module 122 may use any appropriate inter-process communication to implement communication with each other. In some embodiments, the first dedicated module 114 and the second dedicated module 122 communicate with the rendering node 120 in a shared memory manner for data to be rendered, a rendering result, auxiliary data (such as image processing algorithm data, rendering special effect materials, etc.) and/or other data required for executing the rendering task, so as to speed up data transmission.

In the present disclosure, the communication between the first dedicated module 114 and the second dedicated module 122 may use any appropriate communication protocol. An example of the communication protocol is a transmission control protocol (TCP), such as Unix Domain Socket. A further example of the communication protocol is a user datagram protocol (UDP). In short, the embodiments of the present disclosure are not limited in the specific type of the communication protocol.

In some embodiments, the first dedicated module 114 and the second dedicated module 122 may transmit the rendering instruction through a specific message protocol. An example of the message protocol is protocol buffers. A further example of the message protocol is JavaScript Object Notation (JSON). It should be understood that the foregoing examples of the message protocol are for illustrative purposes only. In other embodiments, the message protocol may be any other existing or future-defined message protocol. The various embodiments of the present disclosure are not limited in this respect.

In some embodiments, each rendering node 120 may have its own configuration information, and the configuration information may be defined through the message protocol. Additionally, in some embodiments. the configuration information may be defined as a configuration file, and the rendering task management component 110 and/or the rendering node 120 may maintain the configuration file and communicate (such as encoding and decoding of the rendering instruction) based on a rule defined in the configuration file.

In some embodiments, the configuration information may define startup configuration parameters. An example of the startup configuration parameters is a type of the rendering node 120. A further example of the startup configuration parameters is a storage path of the rendering node 120 (that is, an executable file path). A further example of the startup configuration parameters is at least one control parameter for controlling execution of the rendering task, including but not limited to a rendering frequency, a rendering image size, and a rendering driver.

In this way, even if the same or different rendering nodes 120/renderers 124 have different startup configurations (such as command line parameters, environment variables, etc.) and/or different service scenarios. the rendering task management component 110 and/or the rendering node 120 only need to modify the corresponding configuration files without any other additional modifications.

Further, in some embodiments, the first dedicated module 114 and the second dedicated module 122 are responsible for encoding/decoding content of the message protocol. The message protocol may define various interaction messages to implement interaction of the rendering instruction. In some embodiments, the interaction message may be defined through one or more of the following parameters: a message identification. a type of message parameters (such as an integer type, a character type, etc.), and a priority of the message.

In a specific embodiment, the message protocol may set a rendering resolution message, including parameters of a width and a length of the resolution. In a further specific embodiment, the message protocol may set a rendering frame rate, wherein the rendering frame rate refers to the number of frames rendered per second. In yet a further specific embodiment, the message protocol may set camera parameters, including but not limited to a camera position, a rotation, and a field of view (FOV). In other specific embodiments, the message protocol may set loading of an effect/level (such as a loading path of a rendering effect package and/or a level), playing of a camera animation (such as a camera animation identification), loading/unloading of a 3D resource (such as a loading/unloading resource path), binding of an input and output image (such as an identification of an input and/or output shared memory), and other required rendering control parameters (such as three-dimensional object movement and rotation control, rendering quality control, display or hiding of a specific rendering effect. etc.).

Additionally, in some embodiments, when a new rendering requirement operation needs to be added. the message protocol may define a new message corresponding to the rendering requirement. In this way. customizing a message corresponding to a corresponding rendering instruction through the message protocol can support diversified rendering requirements.

In some embodiments, the rendering task is related to a virtual live stream or a virtual meeting.

For case of understanding only, in some embodiments, a user may run an application such as a virtual live stream or a virtual meeting on a client device of the user. In these specific application scenarios, the user may deploy at least one image acquisition device, such as a camera device, at the client device to acquire audio and video image data of the user. Further, in these specific application scenarios, in addition to the main screen display, there will be other virtual screens to display additional video streams or image information. In addition. the user may have requirements such as a virtual or rendered background. For example, the user expects to change the background to a specific scene, such as a specific meeting room, a starry sky, or the like.

In this case, the user usually needs to render one or more of the following data: audio and video image data acquired by the image acquisition device, image data or algorithm data for a rendering operation, transparent channel data, and other custom types of data.

In some embodiments, the user sends a rendering request related to the rendering task to a cloud. The rendering task management component 110 invokes a corresponding rendering node 120 based on the rendering task to execute a corresponding rendering task.

It should be understood that the foregoing specific scenarios are only used for a specific application scenario of the rendering task processing environment, and should not be construed as a limitation on the application scenarios of the present disclosure. In other words, in other embodiments, the rendering task may be associated with other application scenarios. The various embodiments of the present disclosure are not limited in this respect.

According to various embodiments of the present disclosure, unified collaboration between the rendering task management component 110 and the rendering node 120 is implemented, the maintenance cost when a new rendering node 120 is added is reduced, and the collaboration efficiency and deployment flexibility between the rendering task management component 110 and the rendering node 120 are improved.

It should be understood that FIG. 1 shows only an example rendering task processing environment. According to actual application requirements, a specific implementation environment may be different. Specifically, the numbers and connection relationships of the rendering task management component 110, the rendering nodes 120, the rendering control module 112, the first dedicated module 124, the second dedicated module 122, and the renderers 124 shown in FIG. 1 are only for illustration and indication purposes. In other embodiments, the numbers and connection relationships of the rendering task management component 110, the rendering nodes 120, the rendering control module 112, the first dedicated module 124, the second dedicated module 122, and the renderers 124 may be changed. Further, in other embodiments, the rendering task processing environment may further include other nodes/modules/devices. The scope of the present disclosure is not limited in this respect.

### Example Process

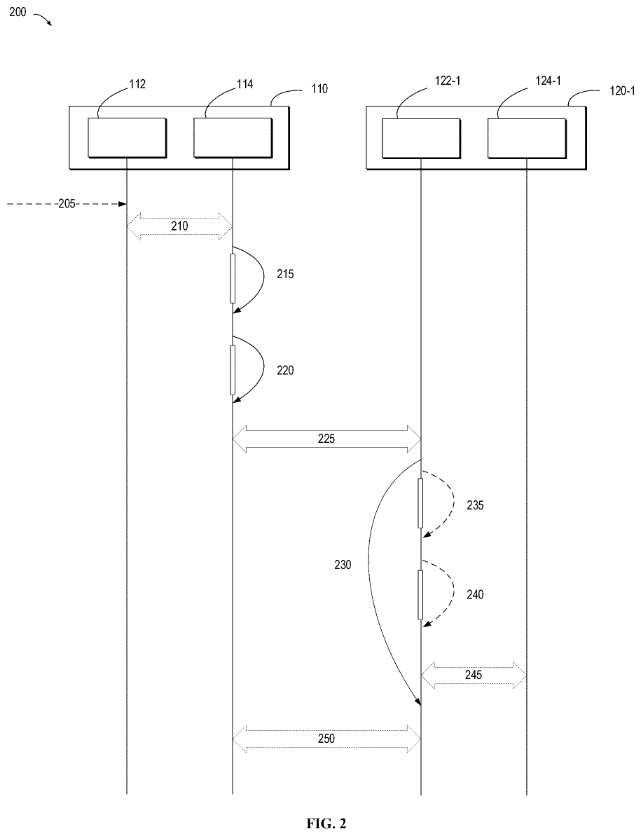

FIG. 2 shows a schematic block diagram of a signaling flow 200 for processing a rendering task according to some embodiments of the present disclosure. For case of discussion, the discussion is made with reference to the environment 100 in FIG. 1. The signaling flow 200 involves the rendering task management component 110 and the rendering node 120-1.

It should be understood that although the signaling flow 200 is discussed with reference to the environment 100 in FIG. 1, as already discussed in the present disclosure, the environment 100 is merely an instance environment of the present disclosure, and therefore the environment 100 should not be construed as a limitation on the implementation environment of the signaling flow 200. Further, although specific operations in the signaling flow 200 occur between specific network elements/modules, in other embodiments. corresponding operations may also be implemented by other network elements/modules. The embodiments of the present disclosure are not limited in this respect.

In some embodiments, the first dedicated module 112 obtains (215), based on a rendering task. configuration information of the rendering node 120-1 for executing the rendering task. Additionally, in some embodiments, obtaining the configuration information of the rendering node 120-1 may be triggered in response to receiving the rendering task. As shown in FIG. 2, the rendering control module 112 of the rendering task management component 110 receives (205) the rendering task and interacts (210) with the first dedicated module 114 for information related to the rendering task, so that the first dedicated module 114 can specifically invoke the rendering node 120-1. It should be understood that the present disclosure is not limited in terms of the source of the rendering task.

In some embodiments, the first dedicated module 112 generates (220), based on the obtained configuration information, a rendering instruction for invoking the rendering node 120-1. Next, the first dedicated module 112 sends (225) the generated rendering instruction to the rendering node 120-1, so that the rendering node 120-1 executes the rendering task.

In some embodiments, the rendering instruction indicates a type of the rendering node 120-1. Alternatively, or in addition, the rendering instruction indicates a storage path of the rendering node 120-1. Alternatively, or in addition, the rendering instruction indicates at least one control parameter for controlling execution of the rendering task, including but not limited to a rendering resolution, a rendering frame rate. loading of rendering data (rendering effect and/or level), control of a camera, and control of a rendering frame time.

Additionally, in some embodiments, the first dedicated module 112 receives a rendering response to the rendering instruction from the second dedicated module 122-1 of the rendering node 120-1.

In some embodiments, the rendering instruction and/or the rendering response are specified through a predefined message protocol.

Additionally, in some embodiments, the rendering task management component 110 sends data to be rendered to the second dedicated module 122-1 of the rendering node 120-1 via its first dedicated module 114. and receives a corresponding rendering result from the second dedicated module 122-1.

Additionally, in some embodiments, the first dedicated module 114 and the second dedicated module 122-1 implement communication with each other based on an inter-process communication method.

In some embodiments, the rendering task management component 110 and the rendering node 120-1 are located in the same physical device/container. In this case, the rendering task management component 110 and the rendering node 120-1 may communicate in a shared memory manner, such as exchanging data to be rendered, a rendering result, auxiliary data (such as image processing algorithm data, rendering special effect materials, etc.) and/or other data required for executing the rendering task. In this way, data transmission speed is increased.

After the rendering node 120-1 receives the rendering instruction via its second dedicated module 122-1, it will invoke a corresponding renderer 124-1 to execute (230) a specific rendering task.

In some embodiments, the second dedicated module 122-1 receives a message including a rendering instruction encoded based on a predefined message protocol, and decodes (235) the received message to obtain the corresponding rendering instruction.

In some embodiments, the second dedicated module 122-1 converts (240) the obtained rendering instruction into a rendering task execution instruction that drives the renderer 124-1 to execute the rendering task, and provides (245) the rendering task execution instruction to the renderer 124-1.

In some embodiments, the second dedicated module 122-1 sends data to be rendered received from the first dedicated module 114-1 to the renderer 124-1, and receives a rendering result from the renderer 124-1. Corresponding to the data to be rendered, the rendering result may also be sent (250) to the first dedicated module 114-1 via the second dedicated module 122-1.

In this way, the rendering task management component 110 and the rendering node 120-1 may interact with each other via the first dedicated module 114-1 and the second dedicated module 122-1 based on the configuration information of the rendering node 120-1, thereby simplifying the invocation process of the rendering node 120-1.

In addition, it should be understood that the process 200 only shows a schematic interaction process between the rendering task management component 110 and the rendering node 120-1. In the real rendering task processing scenario, the rendering task management component 110 may also interact with other rendering nodes (such as the rendering node 120-2) through the first dedicated module 114. Correspondingly, the rendering node 120-1 may also be invoked by other first dedicated modules of other rendering task management components. For the purpose of brevity, similar processes will not be described again.

### Example Method

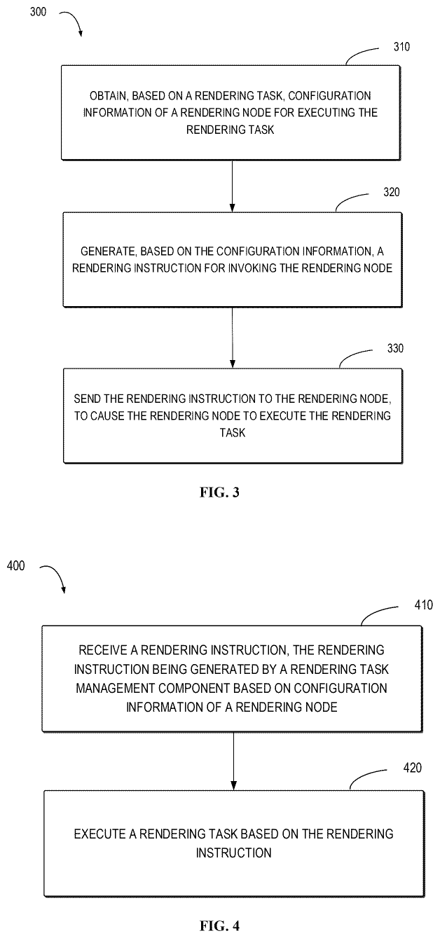

FIG. 3 shows a flowchart of a rendering task processing process 300 implemented according to some embodiments of the present disclosure. For case of discussion, the discussion is made with reference to the environment 100 in FIG. 1. The process 300 may be implemented at the rendering task management component 110.

At block 310, the rendering task management component 110 obtains, based on a rendering task. configuration information of a rendering node 120 for executing the rendering task.

At block 320, the rendering task management component 110 generates, based on the configuration information, a rendering instruction for invoking the rendering node 120.

At block 330, the rendering task management component 110 sends the rendering instruction to the rendering node 120 to cause the rendering node 120 to execute the rendering task.

In some embodiments, the rendering instruction indicates a type of the rendering node 120.

Alternatively, or in addition, in some embodiments, the rendering instruction indicates a storage path of the rendering node 120.

Alternatively, or in addition, in some embodiments, the rendering instruction indicates at least one control parameter for controlling execution of the rendering task.

Alternatively, or in addition, in some embodiments, the process 300 further includes communicating with the rendering node 120 in a shared memory manner. In a specific embodiment, the communication relates to data to be rendered. In a further specific embodiment, the communication relates to a rendering result of the data to be rendered. In yet a further specific embodiment, the communication relates to auxiliary data required for executing the rendering task.

In some embodiments, the rendering task management component 110 generates the rendering instruction and/or sends the rendering instruction by invoking an independent first dedicated module 114.

In some embodiments, the rendering task management component 110 sends data to be rendered to the rendering node 120 via the first dedicated module 114, and receives a rendering result of the data to be rendered from the rendering node 120.

In some embodiments, the first dedicated module 114 is implemented as a computer plug-in.

In some embodiments, the rendering task is related to a virtual live stream or a virtual meeting.

FIG. 4 shows a flowchart of a rendering task processing process 400 implemented according to some embodiments of the present disclosure. For case of discussion, the discussion is made with reference to the environment 100 in FIG. 1. The process 400 may be implemented at the rendering node 120.

At block 410, the rendering node 120 receives a rendering instruction, the rendering instruction being generated by a rendering task management component 110 based on configuration information of the rendering node 120.

At block 420, the rendering node 120 executes a rendering task based on the rendering instruction.

In some embodiments, the rendering node 120 determines a type of the rendering node 120 from the rendering instruction for the execution of the rendering instruction.

Alternatively, or in addition, in some embodiments, the rendering node 120 determines a storage path of the rendering node 120 from the rendering instruction for the execution of the rendering instruction.

Alternatively, or in addition, in some embodiments, the rendering node 120 determines at least one control parameter for controlling the execution of the rendering task from the rendering instruction for the execution of the rendering instruction.

In some embodiments, the rendering node 120 communicates with the rendering task management component 110 in a shared memory manner. In a specific embodiment, the communication relates to data to be rendered. In a further specific embodiment, the communication relates to a rendering result of the data to be rendered. In yet a further specific embodiment, the communication relates to auxiliary data required for executing the rendering task.

In some embodiments, the rendering node 120 receives the rendering instruction by invoking an independent second dedicated module 122.

In some embodiments, the rendering node 120 receives data to be rendered from the rendering task management component 110 via the second dedicated module 122, and sends a rendering result of the data to be rendered to the rendering task management component 110.

In some embodiments, the second dedicated module 122 converts the rendering instruction into a rendering task execution instruction that drives a renderer of the rendering node 120 to execute the rendering task, and provides the rendering task execution instruction to the renderer of the rendering node 120.

In some embodiments, the second dedicated module 122 is implemented as a computer plug-in.

In some embodiments, the rendering task is related to a virtual live stream or a virtual meeting.

### Example apparatuses and devices

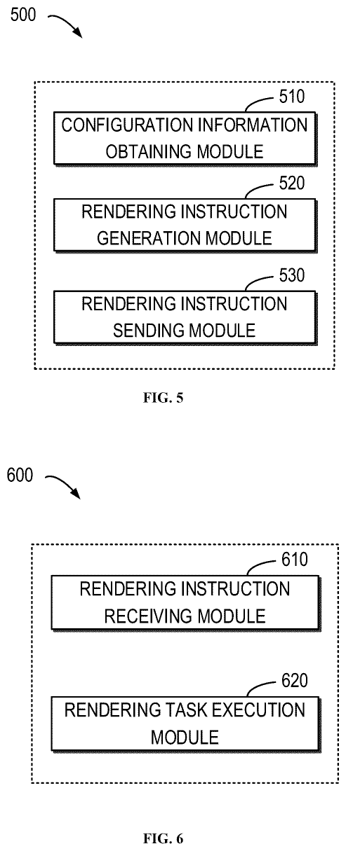

FIG. 5 shows a block diagram of an apparatus 500 for rendering task processing according to some embodiments of the present disclosure. The apparatus 500 may be implemented as or included in the rendering task management component 110. The various modules/components in the apparatus 500 may be implemented by hardware, software, firmware, or any combination thereof.

As shown in the figure, the apparatus 500 includes a configuration information obtaining module 510 configured to obtain, based on a rendering task, configuration information of a rendering node for executing the rendering task. The apparatus 500 also includes a rendering instruction generation module 520 configured to generate, based on the configuration information, a rendering instruction for invoking the rendering node. The apparatus 500 further includes a rendering instruction sending module 530 configured to send the rendering instruction to the rendering node, to cause the rendering node to execute the rendering task.

In some embodiments, the rendering instruction indicates a type of the rendering node 120.

Alternatively, or in addition, in some embodiments, the rendering instruction indicates a storage path of the rendering node 120.

Alternatively, or in addition, in some embodiments, the rendering instruction indicates at least one control parameter for controlling execution of the rendering task.

Alternatively, or in addition, in some embodiments, the apparatus 500 further includes a shared storage module configured to communicate with the rendering node 120 in a shared memory manner. In a specific embodiment, the communication relates to data to be rendered. In a further specific embodiment, the communication relates to a rendering result of the data to be rendered. In yet a further specific embodiment, the communication relates to auxiliary data required for executing the rendering task.

In some embodiments, at least one of the rendering instruction generation module and the rendering task sending module is a dedicated module.

In some embodiments, the apparatus 500 sends data to be rendered to the rendering node 120 via the first dedicated module 114, and receives a rendering result of the data to be rendered from the rendering node 120.

In some embodiments, the first dedicated module 114 is implemented as a computer plug-in.

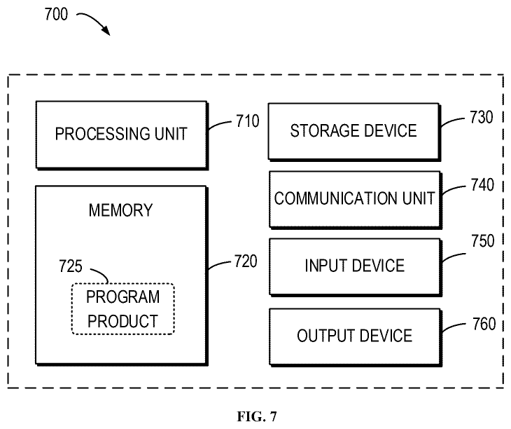

FIG. 6 shows a block diagram of an apparatus 600 for rendering task processing according to some embodiments of the present disclosure. The apparatus 600 may be implemented as or included in the rendering node 120. The various modules/components in the apparatus 600 may be implemented by hardware, software. firmware, or any combination thereof.

As shown in the figure, the apparatus 600 includes a rendering instruction receiving module 610 configured to receive a rendering instruction, the rendering instruction being generated by a rendering task management component based on configuration information of the rendering node, and the apparatus 600 also includes a rendering task execution module 620 configured to execute a rendering task based on the rendering instruction.

In some embodiments, the rendering task execution module 620 is further configured to: determine a type of the rendering node 120 from the rendering instruction for the execution of the rendering instruction.

Alternatively, or in addition, in some embodiments, the rendering task execution module 620 is further configured to: determine a storage path of the rendering node 120 from the rendering instruction for the execution of the rendering instruction.

Alternatively, or in addition, in some embodiments, the rendering task execution module 620 is further configured to: determine at least one control parameter for controlling execution of the rendering task from the rendering instruction for the execution of the rendering instruction.

In some embodiments, the apparatus 600 communicates with the rendering task management component 110 in a shared memory manner. In a specific embodiment, the communication relates to data to be rendered. In a further specific embodiment, the communication relates to a rendering result of the data to be rendered. In yet a further specific embodiment, the communication relates to auxiliary data required for executing the rendering task.

In some embodiments, the apparatus 600 receives the rendering instruction by invoking an independent second dedicated module 122.

In some embodiments, the apparatus 600 receives data to be rendered from the rendering task management component 110 via the second dedicated module 122, and sends a rendering result of the data to be rendered to the rendering task management component 110.

In some embodiments, the second dedicated module 122 converts the rendering instruction into a rendering task execution instruction that drives a renderer of the rendering node 120 to execute the rendering task, and provides the rendering task execution instruction to the renderer of the rendering node 120.

In some implementations, the rendering task is related to a virtual live stream or a virtual meeting.

In some embodiments, the second dedicated module 122 is implemented as a computer plug-in.

FIG. 7 shows a block diagram of a computing device/system 700 in which one or more embodiments of the present disclosure can be implemented. It should be understood that the computing device/system 700 shown in FIG. 7 is merely example, and shall not constitute any limitation on the function and scope of the embodiments described herein. The computing device/system 700 shown in FIG. 7 may be used to implement the rendering task management component 110 or the rendering node 120 in FIG. 1.

As shown in FIG. 7, the computing device/system 700 is in the form of a general-purpose computing device. Components of the computing device/system 700 may include, but are not limited to, one or more processors or processing units 710, a memory 720, a storage device 730, one or more communication units 740. one or more input devices 750, and one or more output devices 760. The processing unit 710 may be a physical or virtual processor and can execute various processes according to a program stored in the memory 720. In a multi-processor system, a plurality of processing units execute computer-executable instructions in parallel to improve a parallel processing capability of the computing device/system 700.

The computing device/system 700 usually includes a plurality of computer storage media. Such media may be any available media accessible by the computing device/system 700, including but not limited to a volatile and non-volatile medium, a detachable and non-detachable medium. The memory 720 may be a volatile memory (for example, a register, a cache, a random access memory (RAM)), a non-volatile memory (for example. a read-only memory (ROM), an electrically erasable programmable read-only memory (EEPROM), or a flash memory) or some combination thereof. The storage device 730 may be a detachable or non-detachable medium. and may include a machine-readable medium, such as a flash drive, a disk, or any other medium, which may be capable of being used for storing information and/or data (for example, training data for training) and may be accessed within the computing device/system 700.

The computing device/system 700 may further include other detachable/non-detachable, volatile/non-volatile storage media. Although not shown in FIG. 7, a disk drive for reading from or writing to a detachable. non-volatile disk (such as a ‘floppy disk’) and an optical disk drive for reading from or writing to a detachable. non-volatile optical disk may be provided. In these cases, each drive may be connected to a bus (not shown) through one or more data medium interfaces. The memory 720 may include a computer program product 725 having one or more program modules configured to perform various methods or actions of various embodiments of the present disclosure.

The communication unit 740 implements communication with a further computing device through a communication medium. Additionally, functions of components of the computing device/system 700 may be implemented by a single computing cluster or a plurality of computing machines that can communicate through communication connections. Therefore, the computing device/system 700 may operate in a networked environment using a logical connection with one or more other servers, a network personal computer (PC), or a further network node.

The input device 750 may be one or more input devices, such as a mouse, a keyboard, and a trackball. The output device 760 may be one or more output devices, such as a display, a speaker, and a printer. The computing device/system 700 may also communicate with one or more external devices (not shown), such as a storage device and a display device, through the communication unit 740 as needed, communicate with one or more devices that enable a user to interact with the computing device/system 700, or communicate with any device (for example, a network card, a modem, etc.) that enables the computing device/system 700 to communicate with one or more other computing devices. Such communication may be performed via an input/output (I/O) interface (not shown).

According to an example implementation of the present disclosure, a computer-readable storage medium having computer-executable instructions or a computer program stored thereon is provided, wherein the computer-executable instructions or the computer program are executed by a processor to implement the method described above.

According to an example implementation of the present disclosure, a computer program product is further provided, wherein the computer program product is tangibly stored on a non-transitory computer-readable medium and includes computer-executable instructions, and the computer-executable instructions are executed by a processor to implement the method described above.

Various aspects of the present disclosure are described herein with reference to the flowcharts and/or block diagrams of the method, the apparatus, the device, and the computer program product implemented according to the present disclosure. It should be understood that each block of the flowchart and/or the block diagram and a combination of the blocks in the flowchart and/or the block diagram may be implemented by computer-readable program instructions.

These computer-readable program instructions may be provided to a processing unit of a general-purpose computer, a special-purpose computer, or a further programmable data processing apparatus, thereby manufacturing a machine, such that the instructions, when executed by the processing unit of the computer or a further programmable data processing apparatus, create a device for implementing a function/action specified in one or more blocks in the flowchart and/or the block diagram. These computer-readable program instructions may also be stored in a computer-readable storage medium. These instructions enable a computer, a programmable data processing apparatus, and/or a further device to work in a specific manner. Therefore, the computer-readable medium storing the instructions includes a product, which includes instructions for implementing various aspects of a function/action specified in one or more blocks in the flowchart and/or the block diagram.

The computer-readable program instructions may be loaded onto a computer, a further programmable data processing apparatus, or a further device, such that a series of operation steps are performed on the computer, a further programmable data processing apparatus, or a further device, to generate a computer-implemented process, such that the instructions executed on the computer, a further programmable data processing apparatus, or a further device implement the function/action specified in one or more blocks in the flowchart and/or the block diagram.

The flowcharts and the block diagrams in the accompanying drawings illustrate a possibly implemented architecture, functions, and operations of the system, the method, and the computer program product according to a plurality of implementations of the present disclosure. In this regard, each block in the flowchart or the block diagram may represent a module, program segment, or part of an instruction, and the module, program segment, or part of the instruction includes one or more executable instructions for implementing the specified logical functions. In some alternative implementations, the functions marked in the blocks may also occur in an order different from that marked in the accompanying drawings. For example, two consecutive blocks may actually be performed substantially in parallel, or may sometimes be performed in a reverse order, depending on a function involved. It should also be noted that each block in the block diagram and/or the flowchart, and a combination of the blocks in the block diagram and/or the flowchart may be implemented by a dedicated hardware-based system that executes specified functions or actions, or may be implemented by a combination of dedicated hardware and computer instructions.

The foregoing describes various implementations of the present disclosure. The foregoing descriptions are for example, not exhaustive, and are not limited to the disclosed implementations. Many modifications and changes are obvious to a person of ordinary skill in the art without departing from the scope and spirit of the described implementations. The selection of terms used herein is intended to best explain the principles of the implementations, the practical application or improvement of the technology in the market, or to enable a person of ordinary skill in the art to understand the implementations disclosed herein.

1. A method of rendering task processing, comprising:
obtaining, based on a rendering task, configuration information of a rendering node for executing the rendering task;
generating, based on the configuration information, a rendering instruction for invoking the rendering node; and
sending the rendering instruction to the rendering node, to cause the rendering node to execute the rendering task.

2. The method of claim 1, wherein the rendering instruction indicates at least one of the following:
a type of the rendering node,
a storage path of the rendering node, or
at least one control parameter for controlling the execution of the rendering task.

3. The method of claim 1, further comprising:
communicating with the rendering node in a shared memory manner, the communication relating to at least one of the following:
data to be rendered,
a rendering result of the data to be rendered, or
auxiliary data required for executing the rendering task.

4. The method of claim 1, wherein at least one of generating the rendering instruction or sending the rendering instruction is implemented by invoking an independent first dedicated module.

5. The method of claim 4, further comprising:
sending data to be rendered to the rendering node via the first dedicated module; and
receiving a rendering result of the data to be rendered from the rendering node.

6. The method of claim 4, wherein the first dedicated module is implemented as a computer plug-in.

7. The method of claim 1, wherein the rendering task is related to a virtual live stream or a virtual meeting.

8. A method of rendering task processing, comprising:
receiving a rendering instruction, the rendering instruction being generated by a rendering task management component based on configuration information of a rendering node; and
executing a rendering task based on the rendering instruction.

9. The method of claim 8, wherein executing the rendering task based on the rendering instruction comprises:
determining at least one of the following from the rendering instruction for the execution of the rendering instruction:
a type of the rendering node,
a storage path of the rendering node, or
at least one control parameter for controlling the execution of the rendering task.

10. The method of claim 8, further comprising:
communicating with the rendering task management component in a shared memory manner, the communication relating to at least one of the following:
data to be rendered,
a rendering result of the data to be rendered, or
auxiliary data required for executing the rendering task.

11. The method of claim 7, wherein receiving the rendering instruction is implemented by invoking an independent second dedicated module.

12. The method of claim 11, further comprising:
receiving data to be rendered from the rendering task management component via the second dedicated module; and
sending a rendering result of the data to be rendered to the rendering task management component.

13. The method of claim 11, further comprising:
converting, by the second dedicated module, the rendering instruction into a rendering task execution instruction that drives a renderer of the rendering node to execute the rendering task; and
providing the rendering task execution instruction to the renderer of the rendering node.

14. The method of claim 11, wherein the second dedicated module is implemented as a computer plug-in.

15. The method of claim 8, wherein the rendering task is related to a virtual live stream or a virtual meeting.

16. (canceled)

17. (canceled)

18. An electronic device, comprising:
at least one processing unit; and
at least one memory coupled to the at least one processing unit and storing instructions for execution by the at least one processing unit, the instructions, when executed by the at least one processing unit, causing the device to perform acts comprising:
obtaining, based on a rendering task, configuration information of a rendering node for executing the rendering task;
generating, based on the configuration information, a rendering instruction for invoking the rendering node; and
sending the rendering instruction to the rendering node, to cause the rendering node to execute the rendering task.

19. (canceled)

20. The electronic device of claim 18, wherein the rendering instruction indicates at least one of the following:
a type of the rendering node,
a storage path of the rendering node, or
at least one control parameter for controlling the execution of the rendering task.

21. The electronic device of claim 18, wherein the acts further comprise:
communicating with the rendering node in a shared memory manner, the communication relating to at least one of the following:
data to be rendered,
a rendering result of the data to be rendered, or
auxiliary data required for executing the rendering task.

22. The electronic device of claim 18, wherein at least one of generating the rendering instruction or sending the rendering instruction is implemented by invoking an independent first dedicated module.

23. The electronic device of claim 22, wherein the acts further comprise:
sending data to be rendered to the rendering node via the first dedicated module; and
receiving a rendering result of the data to be rendered from the rendering node.
